(19) United States
(12) Patent Application Publication
(10) Pub. No.: US 2009/0149353 A1
(43) Pub. Date: Jun. 11, 2009

(54) Polysaccharide Containing Well Treatment Compositions and Methods of Using Same

(75) Inventors: Ragheb B. Dajani, Spring, TX (US); Dale Doherty, Tomball, TX (US); Christina Magelky, Spring, TX (US); Windal Scott Bray, Cypress, TX (US)

Correspondence Address: JONES & SMITH , LLP, 2777 ALLEN PARKWAY, SUITE 800, HOUSTON, TX, 77019, US

(73) Assignee: BJ Services Company

(21) Appl. No.: 11/952,847

(22) Filed: Dec. 7, 2007

(51) Int. Cl. C09K 8/08

(52) U.S. Cl. 507/216

(57) ABSTRACT

Loss of wellbore fluids (such as drilling fluids, completion fluids and workover fluids) into the flow passages of a subterranean formation during well drilling, cementing, completion and workover operations may be reduced or eliminated by introducing into the wellbore in communication with the formation a suspension of a polysaccharide in a aqueous fluid. The aqueous fluid contains water and a delayed viscosification material or agent. Hydration of the polysaccharide may be delayed until after introduction of the composition into the formation. A fluid-impermeable barrier is thereby formed.

### FIELD OF THE INVENTION

The invention relates to a composition for use in a wellbore or in a subterranean formation penetrated by an oil, gas or geothermal well. The composition provides an impermeable barrier to the flow of fluids into the formation or wellbore. The invention further relates to a method of using the composition to prevent loss of wellbore fluids during well drilling, cementing, completion and workover operations.

### BACKGROUND OF THE INVENTION

A problem which sometimes occurs in the oil field is the loss of circulation of special fluids, such as drilling, cementing, completion and workover fluids, into highly permeable zones of the subterranean formation or into the wellbore. Loss of wellbore fluids into the formation or wellbore can dramatically increase the costs of such operations. Such increased costs may be attributable to damage to the drill bit caused by overheating, a decrease in the drilling rate, blowout due to a drop in fluid level in the well, zonal isolation failure due to insufficient cement filling and requisite remedial operations. In some instances, loss circulation fluids may cause the collapse of the formation at the wellbore as well as in-depth plugging of the formation. This, in turn, may cause such extensive damage that the reservoir may have to be abandoned.

In order to stop or retard the loss of wellbore fluids, it is desirable to plug the flow passages responsible for such losses quickly. Often, lost circulation materials (LCMs) which are capable of bridging or blocking seepage into the formation are added to the fluid. While cements and silicates are frequently used as LCMs, the flow properties of such fluids often do not achieve effective plugging. For instance, the large particle size of cements often prevents LCM compositions containing cement from penetrating much beyond a few centimeters into low flow rate channels. With high flow rate channels, the set time of the cement, in relation to the flow rate, often prevents stoppage of the loss of circulation. Thus, such plugs are frequently ineffective to the influx of wellbore fluids.

Alternatives are therefore desired which are effective in reducing the loss of wellbore fluids into flow passages of a formation, as well as in the wellbore, during such well treatment operations as drilling, cementing, completion or workover.

### SUMMARY OF THE INVENTION

The well treatment composition defined herein contains a hydratable polysaccharide and an aqueous fluid. The aqueous fluid contains water or brine. The well treatment composition further may contain at least one delayed viscosification agent or material.

Use of the delayed viscosification agent or material causes substantial delay in viscosification of the well treatment composition until after its introduction into the wellbore. Viscosification of the well treatment composition may therefore be delayed until after the composition reaches the targeted area of the formation or wellbore where creation of an impermeable barrier is desired. Viscosification of the well treatment composition is delayed over time or until downhole temperatures are attained.

In one embodiment of the invention, the hydratable polysaccharide is treated with or coated with a delayed viscosification material prior to its addition to the aqueous fluid. In such instances, glyoxal is the preferred delayed viscosification material.

In another embodiment, a delayed viscosification agent exists as a separate component of the well treatment composition. Suitable delayed viscosification agents in such instances include acetic acid, boric acid, citric acid, inorganic salts and mixtures thereof. In one preferred embodiment, the delayed viscosification agent is acetic acid.

The hydratable polysaccharide is preferably a cellulosic derivative, guar, guar derivative, xanthan or carrageenan. In one preferred embodiment, the hydratable polysaccharide is hydroxyethyl cellulose. The hydratable polysaccharide may optionally be crosslinked, when applicable.

The pH of the well treatment composition is preferably buffered between from about 3.0 to about 8.0, more preferably between from about 4.0 to about 5.0.

Since substantial viscosification of the well treatment fluid is preferably delayed until the well treatment composition reaches the targeted area downhole, the composition introduced into the wellbore may contain a high loading of polysaccharide. Typically, the amount of polysaccharide in the aqueous fluid introduced into the wellbore is between from about 50 pounds to about 1,200 pounds per 1,000 gallons of aqueous fluid.

The viscosity of the well treatment composition, when introduced into the wellbore, is sufficiently low so as to be easily pumpable. The aqueous fluid and polysaccharide interact, especially at elevated temperatures, to hydrate the polysaccharide. While some hydration may result prior to the well treatment composition being pumped into the wellbore, most of the hydration of polysaccharide occurs after the composition is introduced into the wellbore and/or subterranean formation. Agglomeration of the polysaccharide downhole forms a highly viscous plug in the targeted area of the subterranean formation and/or wellbore which typically exhibits elastic and adhesive properties. The plug forms a fluid-impermeable barrier in the formation. For instance, the barrier may be formed in flow passages such as fractures, vugs, or high permeability zones within the formation. The barrier or plug may also form in the wellbore and/or in the formation.

Since the well treatment composition, subsequent to being introduced into the wellbore, is able to form an impermeable barrier, the well treatment composition defined herein is particularly efficacious in reducing the loss of wellbore fluids (such as drilling fluids, completion fluids and workover fluids) in the wellbore and/or into the flow passages of a formation during well drilling, completion and workover operations.

Typically, the well treatment composition is pumped into the wellbore and/or formation as a pill and allowed to viscosity prior to re-starting of the drilling, completion or workover operation.

### DETAILED DESCRIPTION OF THE PREFERRED EMBODIMENTS

The well treatment composition is effective in stopping or minimizing passage of wellbore fluid into a subterranean formation or into a wellbore by the creation of a fluid impermeable barrier. The barrier results upon viscosification of the well treatment composition.

Subsequent to its introduction into the wellbore as a pumpable composition, the well treatment composition viscosifies. Viscosification occurs principally by either hydration and/or optionally crosslinking of the polysaccharide. As a result, the well treatment composition thickens into a highly viscous gel, referred to herein as the “viscosified well treatment composition”. The viscosified well treatment composition typically resembles a rubber-like gelatinous mass and forms the impermeable barrier. The impermeable barrier reduces or eliminates the loss of wellbore fluid into the wellbore and/or the subterranean formation. After formation of the impermeable barrier, drilling, cementing, completion or workover is resumed.

Hydration, viscosification and/or crosslinking of the well treatment composition are principally delayed until after the composition is introduced into or near the formation or targeted area. The presence of the viscosification delay agent or material allows the well treatment composition to be easily pumped into the wellbore.

The well treatment composition is typically a solution and/or suspension at room temperature and remains a solution and/or suspension until hydration of the polysaccharide occurs. Viscosification occurs in or near the subterranean formation, typically in a controlled period of time designed around the placement time to the targeted zone or the formation. This passage of time is sufficient for the well treatment composition to flow into flow passages and to form the rigid gel or viscous well treatment composition. Thus, the polysaccharide of the well treatment composition preferably hydrates at the in-situ site where the plug or impermeable barrier is desired to be located. As a result, upon resuming of the drilling, completion, cementing or workover operation, loss of wellbore fluid is reduced or eliminated.

The well treatment composition is composed of a hydratable polysaccharide and an aqueous fluid. The hydratable polysaccharide is in solution and/or is suspended in the aqueous fluid. The hydratable polysaccharide is preferably a cellulose derivative, guar or guar derivative, xanthan or carrageenan.

Suitable cellulosic derivatives include hydroxyalkyl celluloses, such as hydroxyethyl cellulose, methylhydroxyethyl cellulose, ethylhydroxyethyl cellulose and methylhydroxypropyl cellulose, as well as alkylcarboxyhydroxy celluloses, such as carboxymethylhydroxyethyl cellulose. Suitable as guar or guar derivatives are guar gum, hydroxypropylguar, carboxymethylguar, carboxymethylhydroxypropylguar. The xanthan may be an unmodified xanthan gum, non-acetylated xanthan gum, non-pyruvylated xanthan gum or non-acetylated-non-pyruvylated xanthan gum. Other suitable hydratable polysaccharides include carrageenan, gum Arabic, tara gum, gum ghatti, karaya, tragacanth, pectin, starch, locust bean gum, scleroglucan, tamarind and derivatives thereof. The hydratable polysaccharide is most preferably hydroxyethyl cellulose.

The well treatment fluid further contains a delayed viscosification material or agent. Some materials, such as glyoxal, may be added to the well treatment fluid and/or coated onto the polysaccharide to form a composite. Such composites may be produced by methods known in the art.

The aqueous fluid (in addition to containing water or brine) may further contain a distinct component for delaying viscosification. Suitable delayed viscosification agents for inclusion in the aqueous fluid include various acids, including but not limited to acetic acid, boric acid, citric acid, as well as and/or including inorganic salts (such as potassium chloride, sodium chloride and calcium chloride) as well as mixtures thereof. Typically, the amount of delayed viscosification agent in the aqueous fluid varies based on design specifications that include placement time as well as well conditions.

In those instances where the polysaccharide contains crosslinkable moieties, the well treatment composition may further contain a crosslinking agent. Inclusion of a crosslinking agent in the aqueous fluid of the pumpable well treatment composition may provide attainment of the requisite viscosity of the viscosified well treatment composition while permitting lower amounts of polysaccharide to be used in the pumpable well treatment composition.

Preferred crosslinking agents are those which are heat or time activated. Trivalent or higher polyvalent metal ion containing crosslinking agents are preferred. Examples of the trivalent or higher polyvalent metal ions include boron, titanium, zirconium, aluminum, yttrium, cerium, etc. or a mixture thereof. Boron, titanium and zirconium are preferred and a boron-containing crosslinking agent is most preferred. Examples of titanium salts include titanium diisopropoxide bisacetyl aminate, titanium tetra-2-ethyl hexoxide, titanium tetra-isopropoxide, titanium di-n-butoxy bistriethanol aminate, titanium isopropoxyoctylene glycolate, titanium diisopropoxybistriethanol aminate and titanium chloride. Examples of zirconium salts include zirconium ammonium carbonate, zirconium chloride, sodium zirconium lactate, zirconium oxyacetate, zirconium acetate, zirconium oxynitrate, zirconium sulfate, tetrabutoxyzirconium, zirconium monoacetyl acetonate, zirconium normal butyrate and zirconium normal propylate. The crosslinking agent may optionally be encapsulated.

In addition to a crosslinking agent, the aqueous fluid may further contain a crosslinking delaying agent. The amount of crosslinking delaying agent in the aqueous fluid will vary based on design. Suitable crosslinking or viscosification delaying agents may include organic polyols, such as sodium gluconate; sodium glucoheptonate, sorbitol, mannitol, phosphonates, bicarbonate salt, salts, various inorganic and weak organic acids including aminocarboxylic acids and their salts (EDTA, DTPA, etc.) and citric acid and mixtures thereof. Preferred crosslinking delaying agents include various organic or inorganic acids, sorbitol as well as mixtures thereof.

Such crosslinking delaying agents, when used, are typically desirous to delay or inhibit the effects of the crosslinking agent and thereby allow for an acceptable pump time of the well treatment composition at lower viscosities. Thus, the crosslinking delaying agent inhibits crosslinking of the polysaccharide until after the well treatment composition is placed at or near desired location in the wellbore. In this capacity, the crosslinking delaying agent may be used in lieu of, or in addition to, the delayed viscosification agents referenced above.

In some instances, such as where the crosslinking agent is encapsulated, the encapsulated composite may further function to delay crosslinking. For instance, the aqueous fluid may contain borosilicate glass spheres. Over time and/or upon the application of heat, boron may be released from such spheres. The released boron then functions as a crosslinking agent. Thus, the borosilicate glass spheres function as a crosslinking delaying agent since they delay crosslinking (by preventing the release of boron).

The pH of the well treatment composition is preferably buffered to be between from about 3.0 to about 8.0, most preferably between from about 4.0 to about 5.0. While any acid which is capable of maintaining the well treatment composition to the desired pH may be used, weak organic acids, such as acetic acid, are particularly preferred. In another preferred embodiment, the delayed viscosification agent may further function as a pH buffering system.

An unconventional high loading of polysaccharide may be in solution and/or suspended in the aqueous fluid. As such, the well treatment composition is easily pumpable at conventional rheologies. For instance, the well treatment composition may contain between from about 50 pounds to about 1,200 pounds of polysaccharide per 1,000 gallons of aqueous fluid. Typically, the well treatment composition contains between from about 75 pounds to about 800 pounds of polysaccharide per 1,000 gallons of aqueous fluid. The loading of polysaccharide in the pumpable well treatment composition is dependent on the severity of the fluid losses into the formation. While being easily pumpable, the polysaccharide loading of the well treatment composition is greater than the polymer loading of the LCMs of the prior art.

Substantial viscosification of the well treatment composition occurs subsequent to the composition being pumped downhole. Viscosification occurs after the application of time, temperature, activator, crosslinking agent or a combination thereof. Suitable activators, which may be a component of the aqueous fluid, could include those conventionally employed in the art, such as an encapsulated base or in-situ basic aqueous fluids. Such encapsulated products include those coated with a resin or wax and which exhibit a basic pH. Other activators may further include alkali halides, ammonium halides, potassium fluoride, dibasic alkali phosphates, tribasic alkali phosphates, ammonium fluoride, tribasic ammonium phosphates, dibasic ammonium phosphates, ammonium bifluoride, sodium fluoride, triethanolamine, alkali silicates and alkali carbonates.

In some applications, it may be practical to commingle a gas with the well treatment composition defined herein in order to reduce its density, increase viscosity or increase yield. Suitable gases include nitrogen and carbon dioxide.

The density of the well treatment compositions of the invention may further be adjusted by use of one or more weight modifying agents. The amount of weight modifying agent in the well treating aggregate is such as to impart to the well treating aggregate a desired density. A weighting agent may be utilized to increase the density of the well treatment composition in order to maintain hydrostatic balance in the wellbore. A weight reducing agent may be used in order to provide a density to the well treatment composition which is lower than water.

When present, the amount of weight modifying agent in the well treatment composition may be adjusted to achieve the required final density of the system. The weight modifying agent may be a weighting agent or a weight reducing agent.

The weight modifying agents may be a cementitious material, sand, glass, hematite, silica, sand, fly ash, aluminosilicate, and an alkali metal salt or trimanganese tetra oxide. Further, the weight modifying agent may be a cation selected from alkali metal, alkaline earth metal, ammonium, manganese, iron, titanium and zinc and an anion selected from a halide, oxide, a carbonate, nitrate, sulfate, acetate and formate. For instance, the weight modifying agent may include calcium carbonate, potassium chloride, sodium chloride, sodium bromide, calcium chloride, barite (barium sulfate), hematite (iron oxide), ilmenite (iron titanium oxide), siderite (iron carbonate), manganese tetra oxide, calcium bromide, zinc bromide, zinc formate, zinc oxide or a mixture thereof. In a preferred embodiment, the weight modifying agent is selected from finely ground sand, glass powder, glass spheres, glass beads, glass bubbles, ground glass, borosilicate glass or fiberglass. Glass bubbles and pozzolan spheres are the preferred components for the weight reducing agent.

Thus, the density of the well treatment composition may be easily adjusted by the addition of one or more weight modifying agents to the aqueous fluid. Greater diversity is therefore provided to the operator with the well treatment composition of the invention. The density of the well treatment composition is typically around 9 pounds per gallon. Thus, while the density of the well treatment composition for use in low-density drilling environments may be acceptable without the use of any weight modifying agent, it is possible to add a weighting agent or weight reducing agent to the aqueous fluid where the need arises. For instance, weight modifying agents are often desirable to use in those instances where the desired density of the well treatment composition (prior to it being introduced into the wellbore) is between from about 6 to about 23 pounds per gallon (ppg).

The well treatment composition introduced into the wellbore remains pumpable and, in a preferred embodiment, is pumped into the wellbore as a pill. The low viscosity of the well treatment composition facilitates ease in passage of the composition through the drill bit

As the well treatment composition approaches the target area, the viscosity of the composition increases as hydration and/or crosslinking of the polysaccharide proceeds under downhole conditions. The increase in viscosity of the well treatment composition results in the formation of agglomerates which further thicken to form a plug or impermeable barrier. The barrier or plug may form in or outside of the wellbore. Such barriers may be formed, for instance, in flow passages within the formation. The formation of such barriers or plugs in the wellbore or in the formation enables a reduction of loss of fluid into the formation.

Typically, the viscosity of the viscosified well treatment composition is from about 500 to greater than or equal to 2,000,000 cP. Such high viscosities are attributable to the high loading of polysaccharide in the well treatment composition. The hydrated well treatment composition is comparable to a large rubbery mass. Permeability of the formation, or fluid lost to flow channels is reduced or eliminated by the formation of the rigid barrier created by the hydrated well treatment composition.

The loss of fluid into the formation, fracture or wellbore is mitigated by the viscosity of the hydrated well treatment composition. In some instances, the hydrated well treatment composition forms a filter cake, such as in a permeable medium where filtrates may be lost. In other instances, loss circulation may be combated merely by the high viscosity of the hydrated well treatment composition (without the formation of a filter cake). This is especially the case in those instances where the formation is not permeable or exhibits low permeability, such as a shale formation.

The well treatment composition defined herein offers several advantages over the alternatives offered by the loss circulation materials of the prior art. For instance, the well treatment composition contains commonly used materials versus the LCMs of the prior art. Further, the well treatment compositions defined herein are easier to prepare than the LCMs of the prior art. Additionally the well treatment composition defined herein does not require additional bridging agents or materials or external activation, such as the introduction of an activator in the wellbore. The presence of such external activation measures often requires the use of additional workstrings or annular flow paths. Further, the well treatment composition defined herein is able to penetrate further into the loss zone than the LCMs of the prior art.

In contrast to conventional cement-containing LCMs, the well treatment composition defined herein further does not typically contain a cement. As such, it is not necessary to halt operations for extended periods of time in order for cement to set. When using the cement-containing LCMs of the prior art, the operation is typically required to stop operations for 4 to 8 hours while the cement sets. Since the well treatment composition defined herein is quick to react and set, downtime of the operation is greatly minimized. Thus, determining whether a given LCM will be suitable for a given operation requires dramatically less time with the well treatment composition defined herein in light of the ability of the composition to rapidly build viscosity.

Since the well treatment composition defined herein may provide extreme rigidity, it may be used to plug horizontal or deviated zones as well as stabilize a wellbore requiring a an off-bottom liner or casing. In the latter, the well treatment composition may serve as a corner base for the cementitious slurry. When viscosified, the composition forms a downhole plug and renders unnecessary the need for a packer or other mechanical device. Thus, the plug may serve as a false bottom and render it unnecessary to run the liner to a greater depth. As a result, the plug composed of the viscosified well treatment composition is capable of keeping the open hole portion beneath the liner isolated.

The following examples are illustrative of some of the embodiments of the present invention. Other embodiments within the scope of the claims herein will be apparent to one skilled in the art from consideration of the description set forth herein. It is intended that the specification, together with the examples, be considered exemplary only, with the scope and spirit of the invention being indicated by the claims which follow.

All percentages set forth in the Examples are given in terms of weight units except as may otherwise be indicated.

### EXAMPLES

### Example 1

This Example illustrates the preparation of a hydroxyethyl cellulose loss circulation pill. A loss circulation pill consisting of a non-crosslinked gel was prepared by adding hydroxyethyl cellulose (HEC), commercially available as FL-52 from BJ Services Company, to water and pre-hydrating about 10 percent by weight of the HEC for about 35 minutes at ambient temperature. As an option, an aqueous solution containing 40 volume percent of glyoxal was added to the fluid. Prior to heating to final temperature, an optional amount of acetic acid was added, with the remaining HEC. Heat was then used as an activator.

### Examples 2-26

Time and viscosity data was recorded every 60 seconds for the well treatment pill prepared above on a Grace M3500 rotational rheometer at 300 RPM at a designated temperature. The results are set forth in Table I. The Viscosification Time represents the time required for hydration is noted in the Table.

TABLE I

| | | | | | | Viscosification | |
|---|---|---|---|---|---|---|---|
| | | | | | | Time | |
| | Composition | | | | | Grace M 3500 | |
| Ex | | FL-52 | Acetic | glyoxal | Temp | 1000 cP | Final |
| no. | H₂O g | (HEC) g | Acid g | 40% g | ° F. | hr:min | cP |
| 2 | 314.29 | 50 | | | 80 | 0:25 | 1000+ |
| 3 | 299.7 | 50 | 0.3 | 0 | 80 | 1:12 | 1000+ |
| 4 | 289.7 | 50 | 0.3 | 10 | 80 | 1:51 | 1000+ |
| 5 | 314.29 | 50 | | | 100 | 0:16 | 1000+ |
| 6 | 299.7 | 50 | 0.3 | 0 | 100 | 0:37 | 1000+ |
| 7 | 289.7 | 50 | 0.3 | 10 | 100 | 0:53 | 1000+ |
| 8 | 314.29 | 50 | | | 120 | 0:09 | 1000+ |
| 9 | 289.7 | 50 | 0.3 | 10 | 120 | 0:25 | 1000+ |
| 10 | 314.83 | 25 | 0.17 | 10 | 120 | 0:32 | 1000+ |
| 11 | 300 | 50 | | | 130 | 0:09 | 1000+ |
| 12 | 299.7 | 50 | 0.3 | 0 | 130 | 0:17 | 1000+ |
| 13 | 289.7 | 50 | 0.3 | 10 | 130 | 0:19 | 1000+ |
| 14 | 279.7 | 50 | 0.3 | 20 | 130 | 0:23 | 1000+ |
| 15 | 249.7 | 50 | 0.3 | 50 | 130 | 0:32 | 1000+ |
| 16 | 300 | 50 | | | 140 | 0:09 | 1000+ |
| 17 | 299.7 | 50 | 0.3 | 0 | 140 | 0:17 | 1000+ |
| 18 | 219.7 | 50 | 0.3 | 80 | 140 | 0:37 | 1000+ |
| 19 | 299.7 | 50 | 0.3 | 0 | 160 | 0:20 | 1000+ |
| 20 | 249.7 | 50 | 0.3 | 50 | 160 | 0:27 | 1000+ |
| 21 | 229.7 | 50 | 0.3 | 70 | 160 | 0:28 | 1000+ |
| 22 | 199.7 | 50 | 0.3 | 100 | 160 | 0:35 | 1000+ |
| 23 | 300 | 50 | | | 180 | 0:09 | 1000+ |
| 24 | 199.7 | 50 | 0.3 | 100 | 180 | 0:30 | 1000+ |
| 25 | 300 | 50 | | | 200 | 0:10 | 1000+ |
| 26 | 239 | 50 | 1 | 60 | 200 | 0:23 | 1000+ |

Table I illustrates the ability to delay viscosification of the well treatment composition to achieve the required placement time.

From the foregoing, it will be observed that numerous variations and modifications may be effected without departing from the true spirit and scope of the novel concepts of the invention.

What is claimed is:

1. A well treatment composition comprising an aqueous fluid and a hydratable polysaccharide wherein the amount of polysaccharide in the well treatment composition is between from about 50 pounds to about 1,200 pounds per 1,000 gallons of aqueous fluid and further wherein:
(a.) the hydratable polysaccharide is coated or treated with a delayed viscosification material; or
(b) the well treatment composition further contains a delayed viscosification agent.

2. The well treatment composition of claim 1, wherein the hydratable polysaccharide is coated or treated with a delayed viscosification material.

3. The well treatment composition of claim 2, wherein the delayed viscosification material is glyoxal.

4. The well treatment composition of claim 1, wherein the hydratable polysaccharide is selected from the group consisting of cellulosic derivatives, guar and guar derivatives, xanthan and carrageenan.

5. The well treatment composition of claim 4, wherein the hydratable polysaccharide is selected from the group consisting of hydroxyalkyl celluloses, alkylcarboxyhydroxy celluloses.

6. The well treatment composition of claim 5, wherein the hydratable polysaccharide is selected from the group consisting of hydroxyethyl cellulose, methylhydroxyethyl cellulose, ethylhydroxyethyl cellulose, carboxymethylhydroxyethyl cellulose and methylhydroxypropyl cellulose.

7. The well treatment composition of claim 4, wherein the hydratable polysaccharide is selected from the group consisting of guar gum, hydroxypropylguar, carboxymethylguar, carboxymethylhydroxypropylguar, locust bean gum, tara gum, karaya gum, arabic gum, ghatti gum, tragacanth gum, xanthan gum, pectin, starch, scleroglucan, tarmarind and carrageenan.

8. The well treatment composition of claim 6, wherein the hydratable polysaccharide is hydroxyethyl cellulose.

9. The well treatment composition of claim 8, wherein the hydroxyethyl cellulose is coated or treated with glyoxal.

10. The well treatment composition of claim 1, wherein the hydration delay agent is selected from the group consisting of acetic acid, glyoxal and mixtures thereof.

11. The well treatment composition of claim 1, wherein the composition is buffered to a pH of between from about 3.0 to about 8.0.

12. The well treatment composition of claim 11, wherein the composition is buffered to a pH of between about 4.0 to about 5.0.

13. The well treatment composition of claim 1, further comprising a weight modifying agent.

14. The well treatment composition of claim 1, wherein the density of the composition is between from about 6 to about 23 ppg.

15. A well treatment composition comprising water, a hydratable polysaccharide and a viscosification delay agent, optionally coated onto or contained within the polysaccharide:
(a) the amount of polysaccharide in the well treatment composition is between from about 50 pounds to about 1,200 pounds per 1,000 gallons of water;
(b) the hydratable polysaccharide is hydroxyethyl cellulose; and
(c) the composition is buffered to a pH of between from about 3.0 to about 8.0.

16. The well treatment composition of claim 15, wherein the composition is buffered to a pH of between about 4.0 to about 5.0

17. A method of treating a well in communication with a subterranean formation which comprises:
(a) preparing the well treatment composition of claim 1 and introducing the well treatment composition into the well;
(b) increasing the viscosity of the well treatment composition; and
(c) forming a fluid-impermeable barrier within the formation or within the wellbore from the composition resulting from step (b) and thereby reducing the permeability of the formation, mitigating loss of fluid into the formation and/or reducing fluid communication within the wellbore.

18. The method of claim 17, wherein the composition resulting from step (b) is a filter cake.

19. The method of claim 16, wherein well treatment composition of step (a) is introduced into the well in the form of a loss circulation pill.

20. The method of claim 16, wherein the well treatment composition of step (a) is prepared on location.

21. A method for reducing the loss of fluids into flow passages of a subterranean formation during well drilling, completion, or workover operations which comprises introducing into the flow passages an effective amount of the well treatment composition of claim 1 and then hydrating the well treatment composition, thereby reducing the loss of fluids into the flow passages upon resuming of the well drilling, completion or workover operation.

22. A method for reducing the loss of wellbore fluids into flow passages of a subterranean formation during well drilling, completion or workover operations, the wellbore fluids being selected from the group consisting of drilling fluids, completion fluids and workover fluids, the method comprising:
(a) introducing the well treatment composition of claim 1 into the flow passages of the formation;
(b) increasing the viscosity of the well treatment composition in-situ by hydrating the polysaccharide and thereby reducing the loss of fluid upon resuming the well drilling, completion or workover operation.
